(19) United States
(12) Patent Application Publication
(10) Pub. No.: US 2013/0322647 A1
(43) Pub. Date: Dec. 5, 2013

(54) NOISE REDUCTION APPARATUS

(71) Applicant: SAMSUNG ELETRONICS CO., LTD., Gyeonggi-do (KR)

(72) Inventor: Byung-Soo KIL, Gyeonggi-do (KR)

(73) Assignee: SAMSUNG ELETRONICS CO., LTD., Gyeonggi-do (KR)

(21) Appl. No.: 13/894,617

(22) Filed: May 15, 2013

(30) Foreign Application Priority Data
May 30, 2012 (KR) 10-2012-0057454

(51) Int. Cl. G10K 11/00; H02J 7/00

(52) U.S. Cl. CPC G10K 11/002; H02J 7/0052
USPC 381/74; 320/107

(57) ABSTRACT

An apparatus for reducing an Electro-Magnetic Interference (EMI) noise of an electronic device during supplying of power from a charging device. includes Common Mode Choking Coils (CMCCs) to permit the electronic device to conform to various national standards regarding emissions of radiation. The CMCC can be arranged in the charging device and a power supply line of the electronic device or in an earphone connected with the electronic device or interposed there between. The higher frequency of radiation noise is reduced while DC levels are not affected by the choking coils. The radiation noise being emitted from the electronic device at the time of interworking with the charging device is greatly reduced.

### CLAIM OF PRIORITY

This application claims the benefit of priority under 35 U.S.C. §119(a) from a Korean Patent Application filed in the Korean Intellectual Property Office on May 30, 2012 and assigned Serial No. 10-2012-0057454, the contents of which are herein incorporated by reference in its entirety.

### BACKGROUND OF THE INVENTION

1. Field of the Invention

The present invention relates to a noise reduction apparatus for electronic devices, including portable electronic devices.

2. Description of the Related Art

To market an electronic device in a specific country, the electronic device typically has to pass electromagnetic wave test regulations of the specific country. According to this process, each country prepares its own electromagnetic wave test regulations to enable only service providers who have passed the regulations to distribute or sell the electronic device in a corresponding country. For example, Europe provides Global Certification Forum (GCF) approval regulations, which integrate the regulations of European countries that use a Global System for Mobile communication (GSM) network and provide the international standards. The GCF approval regulations mainly regulate four tests such as Full Type Approval (FTA), Electro-Magnetic Compatibility (EMC), Safety, and Specific Absorption Rate (SAR). Among them, the EMC test has to pass a Radiated Emission (RE) test for measuring Electro-Magnetic Interference (EMI).

The aforementioned RE test refers to a test of placing/connecting a charger into the electronic device, in a state in which a maximal radiation noise can be emitted from an electronic device, and measuring a radiation noise emitted from the electronic device. In the conventional art, a bead was built in the charger to reduce the radiation noise emitted from the electronic device. But, recently, as smart phones are launched, there are insufficient points for reducing radiation noise emitted from various applications of the smart phones. Accordingly, in order to pass the electromagnetic wave tests of a number of different nations, there is an urgent need to develop an apparatus for reducing the radiation noise emitted from the electronic device.

### SUMMARY OF THE INVENTION

An exemplary aspect of the present invention is to substantially solve at least some of the above problems and/or disadvantages and to provide at least the advantages below. Accordingly, one aspect of the present invention is to provide an apparatus for building common mode choking coils in an electronic device and a charger or earphone that effectively reduce a radiation noise emitted from the electronic device.

Another exemplary aspect of the present invention is to provide an apparatus for effectively reducing a radiation noise emitted from an electronic device and preventing an additional improvement cost from being incurred from a failure of passing a Radiated Emission (RE) test.

The above exemplary aspects are achieved by providing a noise reduction apparatus.

According to an exemplary aspect of the present invention, an apparatus for reducing an Electro-Magnetic Interference (EMI) noise of an electronic device during supplying of power from a charging device is provided. The apparatus preferably includes Common Mode Choking Coils (CMCCs) intervened (arranged/interposed) in the charging device and a power supply line of the electronic device or in an earphone connected with the electronic device, and reduces a radiation noise emitted out from the electronic device at the time of interworking with the charging device.

According to an exemplary aspect of the invention, the charging device preferably includes an adapter, a cable of a predetermined length, and a connector body. The adapter converts Alternating Current (AC) power supplied from the external, into Direct Current (DC) power. The cable has one end electrically coupled to the adapter. The connector body includes a connector that is installed at the other end of the cable and is electrically coupled to a connector port of the electronic device. The common mode choking coil is intervened (interposed) in any one of the connector body, the cable, and the adapter that are in a power supply line of the charging device.

Preferably, the electronic device may include a connector port, a power supply unit, and a main board. The connector port is electrically coupled with a connector of the charging device. The power supply unit is electrically coupled with the connector port, and accepts power applied from the charging device. The main board includes a processor unit operating by power applied from the power supply unit. The common mode choking coil is interposed in any one of places between the connector port and the power supply unit and between the power supply unit and the main board. The Common mode choking coil reduces the radiation noise emitted from the electronic device while charging, so as to comply with various national standards regulating an amount of radiation noise permitted.

Preferably, the earphone may include an ear jack plug, a cable of a predetermined length, a speaker, and a microphone. The ear jack plug is electrically coupled with an ear jack of the electronic device. The cable has one end electrically coupled to the ear jack plug. The speaker is installed at the other end of the cable, and receives an input of an electrical signal from the electronic device, reproduces a voice signal, and generates a sound source. The microphone is positioned between the ear jack plug and the speaker, and receives an input of a voice signal from a user. The common mode choking coil is intervened in any one of the speaker and the microphone.

Preferably, the common mode choking coil may constructed to include a hollow type ferrite core and two wires of a 5 Voltage (V) line and a ground line that are wound on the hollow type ferrite core several times in reverse direction.

According to an exemplary aspect of the invention, the common mode choking coil may reduce a common mode noise introduced into the two wires of the 5V line and the ground line of the common mode choking coil.

According to an exemplary aspect of the invention, the common mode choking coil may allow a normal mode current to pass the two wires of the 5V line and the ground line of the common mode choking coil.

According to an exemplary aspect of the invention, the common mode choking coil can act as inductance for the radiation noise emitted from the electronic device.

According to an exemplary aspect of the invention, the noise reduction apparatus can reduce a maximum radiation noise, which is emitted at a time the electronic device performs at least one function at the same time during a charging operation by the charging device.

According to an exemplary aspect of the invention, the electronic device can perform at least one of a camera function and at least one application execution function during the charging operation.

According to an exemplary aspect of the invention, the electronic device comprises a communicating portable terminal.

According to another exemplary aspect of the present invention, a charging device for charging an electronic device is provided. The charging device preferably includes an adapter, a cable of a predetermined length, a connector body, and a common mode choking coil. The adapter converts AC power supplied from the external, into DC power. The cable has one end electrically coupled to the adapter. The connector body includes a connector that is installed at the other end of the cable and is electrically coupled to a connector port of the electronic device. The common mode choking coil is intervened in any one of the connector body, the cable, and the adapter that are in a power supply line of the charging device. The charging device is constructed to reduce a radiation noise emitted from the electronic device during charging of the electronic device.

According to an exemplary aspect of the invention, the common mode choking coil may be constructed to include a hollow-type ferrite core and two wires of a 5V line and a ground line that are wound on the hollow type ferrite core several times in reverse direction.

According to an exemplary aspect of the invention, the common mode choking coil may reduce a common mode noise introduced into the two wires of the 5V line and the ground line of the common mode choking coil.

According to an exemplary aspect of the invention, the common mode choking coil may allow a normal mode current to pass the two wires of the 5V line and the ground line of the common mode choking coil.

According to a further exemplary aspect of the present invention, an electronic device for receiving power supply from a charging device is provided. The electronic device can includes a connector port, a power supply unit, a main board, and a common mode choking coil. The connector port is electrically coupled with a connector of the charging device. The power supply unit is electrically coupled with the connector port, and accepts power applied from the charging device. The main board includes a processor unit operating by power applied from the power supply unit. The common mode choking coil is intervened in any one of places between the connector port and the power supply unit and between the power supply unit and the main board. The electronic device is constructed to reduce a radiation noise emitted from the electronic device during a charging operation by the charging device.

According to an exemplary aspect of the invention, the common mode choking coil may be constructed to include a hollow type ferrite core and two wires of a 5V line and a ground line that are wound on the hollow type ferrite core several times in reverse direction.

According to an exemplary aspect of the invention, the common mode choking coil may reduce a common mode noise introduced into the two wires of the 5V line and the ground line of the common mode choking coil.

According to an exemplary aspect of the invention, the common mode choking coil may allow a normal mode current to pass the two wires of the 5V line and the ground line of the common mode choking coil.

According to yet another exemplary aspect of the present invention, an earphone for reducing a noise emitted from an electronic device is provided. The earphone includes an ear jack plug, a cable of a predetermined length, a speaker, a microphone, and a common mode choking coil. The ear jack plug is electrically coupled with an ear jack of the electronic device. The cable has one end electrically coupled to the ear jack plug. The speaker is installed at the other end of the cable, and receives an input of an electrical signal from the electronic device, reproduces a voice signal, and generates a sound source. The microphone is positioned between the ear jack plug and the speaker, and receives an input of a voice signal from a user. The common mode choking coil is intervened in any one of the speaker and the microphone. The earphone is constructed to reduce a radiation noise emitted from the electronic device during charging of the electronic device.

According to an exemplary aspect of the invention, the common mode choking coil may be constructed to include a hollow type ferrite core and two wires of a 5V line and a ground line that are wound on the hollow type ferrite core several times in reverse direction.

According to an exemplary aspect of the invention, the common mode choking coil may reduce a common mode noise introduced into the two wires of the 5V line and the ground line of the common mode choking coil.

According to an exemplary aspect of the invention, the common mode choking coil may allow a normal mode current to pass the two wires of the 5V line and the ground line of the common mode choking coil.

### BRIEF DESCRIPTION OF THE DRAWINGS

The above and other exemplary objects, features and advantages of the present invention will become more apparent to a person of ordinary skill in the art from the following detailed description when taken in conjunction with the accompanying drawings in which:

FIG. 1 is a diagram illustrating an exemplary embodiment of a Radiated Emission (RE) test that is used to test an electronic device according to the present invention;

FIGS. 2A and 2B are diagrams illustrating exemplary embodiments of an electronic device in which a maximum radiation noise can be emitted from the electronic device according to an exemplary embodiment the present invention;

FIG. 3 is a diagram illustrating the whole connection relationship of an electronic device, an earphone, and a charging device according to an exemplary embodiment of the present invention;

FIG. 4 is a diagram illustrating a construction of a common mode choking coil according to an exemplary embodiment of the present invention;

FIGS. 5A and 5B are diagrams illustrating the direction of each magnetic flux when a radiation noise and an electric current pass common mode choking coils according to an exemplary embodiment of the present invention;

FIG. 6 is a flowchart illustrating an exemplary operation of a charging device according to the present invention;

FIG. 7 is a block diagram illustrating constructions of an electronic device and a charging device according to an exemplary embodiment of the present invention;

FIGS. 8A and 8B are graphs illustrating exemplary embodiments of the present invention showing experimental measurements of a radiation noise emitted from an electronic device before and after using a common mode choking coil according to an exemplary embodiment of the present invention; and

FIG. 9 is a diagram illustrating a construction of an earphone according to an exemplary embodiment of the present invention.

### DETAILED DESCRIPTION

Preferred exemplary embodiments of the present invention will be described herein below with reference to the accompanying drawings. In the following description, well-known functions or constructions may not be described in detail when their inclusion would obscure appreciation of the subject matter of the present invention by a person of ordinary skill in the art with unnecessary detail of the well-known structures or functions. Additional terms described herein below, which are defined considering functions in the present invention, can be different depending on user and operator's intention or practice. Therefore, the terms should be defined on the basis of the disclosure throughout this specification.

The present invention is described herein below with respect to particular exemplary embodiments and with reference to certain drawings, but the claimed invention is not limited thereto, and rather, is set forth only by the claims The drawings described are illustrative and are non-limiting. In the drawings, for illustrative purposes, the size of some of the elements may be exaggerated and not drawn to a particular scale. Where the term “comprising” is used in the present description and claims, said term does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

Furthermore, the terms “first”, “second”, “third” and the like, if used in the description and in the claims, are provided for distinguishing between similar elements and not necessarily for describing a sequential or chronological order. It is to be understood that the terms so used are interchangeable under appropriate circumstances (unless clearly disclosed otherwise) and that the exemplary embodiments of the invention described herein are capable of operation in other sequences and/or arrangements than are described or illustrated herein.

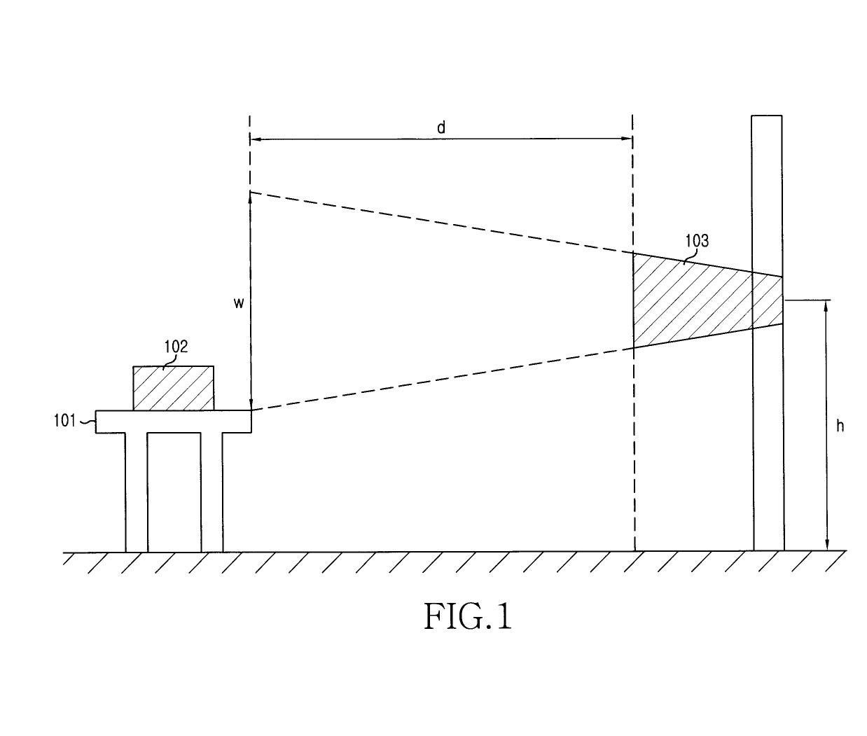

FIG. 1 is a diagram illustrating an exemplary embodiment of a Radiated Emission (RE) test according to the present invention. First, to launch an electronic device in a specific country, the electronic device has to pass electromagnetic wave test regulations of the specific country. Accordingly, each country prepares its own electromagnetic wave test regulations to enable only a service provider who has passed the regulations to distribute or sell the electronic device within a corresponding country who provided the electronic wave test. For example, Europe provides Global Certification Forum (GCF) approval regulations, which integrate the regulations of European countries that use a Global System for Mobile communication (GSM) network and provide the international standards. The GCF approval regulations mainly regulate four tests such as Full Type Approval (FTA), Electro-Magnetic Compatibility (EMC), Safety, and Specific Absorption Rate (SAR). As used herein, Electro-Magnetic Interference (EMI) is interpreted as “electromagnetic interference” or “electromagnetic hindrance”. More particularly, EMI can be defined as radiated or conducted electromagnetic waves giving hindrance to functions of other devices. In other words, EMI represents that a specific electronic device has influence upon nearby other electronic devices, weakens operations thereof, and causes erroneous operations thereof Electro-Magnetic Susceptibility (EMS) can be defined as electromagnetic tolerance, i.e., the ability of any device normally operating despite the influence of electromagnetic wave radiation or electromagnetic wave conduction upon the device. EMS, the concept corresponding with EMI, is called protection from electromagnetic waves as well. Electro-Magnetic Compatibility (EMC), which is interpreted as electromagnetic suitability or compatibility, can be defined as the ability of a device capable of securing performance without interference in other devices and interference from the other devices. In other words, EMC is a comprehensive meaning including both EMI and EMS.

The RE test, an item included in the EMC test among the aforementioned four tests, is a test used for measuring EMI. FIG. 1 illustrates an exemplary embodiment of performing the RE test. An electronic device 102, which constitutes a target for measuring a radiation noise, is placed on a rotary table 101, a measurement antenna 103 is used to measure a radiation noise emitted from the electronic device 102 at a position spaced a set distance “(d)” apart from the rotary table 101.

More particularly, the measurement antenna 103 measures the radiation noise emitted from the electronic device in the upper, lower, vertical, and horizontal directions of a set range “(w)” in a range from 30 Mega Hertz (MHz) to 1 Giga Hertz (GHz) from a set height “(h)”. The electronic device 102 is RE tested in a state in which a maximum radiation noise can be emitted from the electronic device 102.

For example, the state in which the maximum radiation noise can be emitted from the electronic device 102 refers to, a state in which a user operates a camera and runs a specific application while putting an earphone into the electronic device 102. In this state, the maximum radiation noise is emitted from the electronic device 102. Thus, the RE test measures the radiation noise of the electronic device 102, in the state in which the maximum radiation noise can be emitted from the electronic device 102. Accordingly, if the electronic device 102 does not meet a set specification of the RE test, the electronic device 102 cannot acquire European compulsory standards approval.

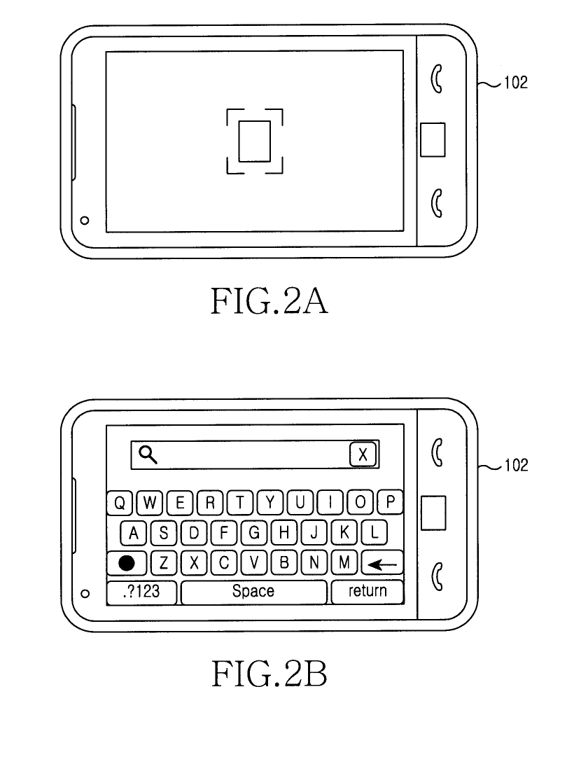

FIGS. 2A to 2B are diagrams illustrating exemplary embodiments in which a maximum radiation noise can be emitted from the electronic device 102 according to the present invention. As aforementioned in detail in FIG. 1, the RE test measures the radiation noise of the electronic device 102 undergoing the RE test in the state in which the maximum radiation noise can be emitted from the electronic device. In other words, FIGS. 2A to 2B illustrate the exemplary embodiments of the state in which the maximum radiation noise can be emitted from the electronic device.

FIG. 2A illustrates an exemplary embodiment of a state of the electronic device 102 in which a maximum radiation noise can be emitted from the electronic device while undergoing an RE test. More particularly, FIG. 2A illustrates a state of executing a camera function of the electronic device. If it is identified that the electronic device undergoing the RE test emits a radiation noise higher than a set specification in the state in which the maximum radiation noise can be emitted, the electronic device cannot acquire standards approval of a corresponding country. Accordingly, to undergo the RE test successfully, the electronic device while emitting a maximum radiation noise must do so at or below a safety level set by the appropriate country or authority . In this exemplary embodiment of the invention, the electronic device operates a camera, which typically emits relatively greater radiation noise from the electronic device than most other functions of the device. In other words, when an instruction of operating the camera is input to the electronic device undergoing the RE test, the electronic device performs the camera function as would be performed when in such device is in possession of a user.

FIG. 2B illustrates another exemplary embodiment of an operational state in which a maximum radiation noise can be emitted from the electronic device 102 undergoing an RE test. In, FIG. 2B illustrates an operational state of executing a specific application stored in the electronic device. Here, the specific application refers to a game stored in the electronic device 102, a sound source, a Social Network Service (SNS) and the like. When a user executes the specific application stored in the electronic device, the radiation noise emitted from the electronic device 102 increases from when the device is in an idle state, for example. Accordingly, to emit a higher radiation noise from the electronic device, in this exemplary embodiment a specific application with operating the camera of the electronic device is executed.

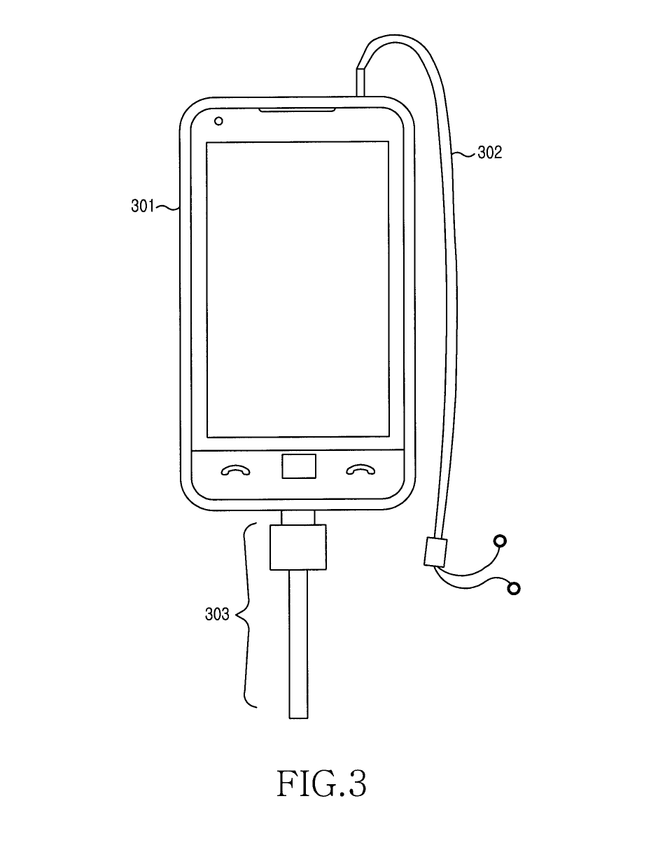

FIG. 3 is a diagram illustrating the whole connection relationship of an electronic device, an earphone, and a charging device according to the present invention.

First, if a user connects an earphone 302 to an electronic device 301 while operating a camera and executing a specific application, the electronic device 301 completes a state in which a maximum radiation noise can be emitted. Here, the state in which the maximum radiation noise can be emitted refers to not a state in which the user can identify that the maximum radiation noise is emitted from the electronic device 301 but that the state in which the maximum radiation noise can be emitted is ready. As described above, in this example, the maximum radiation noise is not emitted from the electronic device 301 before a charging device 303 is connected to the electronic device 301. In other words the maximum radiation noise is emitted from the electronic device 301 only after the charging device 303 is connected to the electronic device 301. Accordingly, if the user connects the earphone 302 and connects the charging device 303 to the electronic device 301 while undergoing the RE test with operating the camera and executing the specific application in the electronic device 301, a measurement antenna (such as shown in FIG. 1 but not limited to such illustration) can receive and measure the maximum radiation noise emitted from the electronic device 301.

The charging device 303 can include a connector body and a cable. In more detail, the connector body or the cable can include an electronic element for reducing a radiation noise emitted from the electronic device 301. Here, the electronic element according to an exemplary embodiment of the present invention can include a common mode choking coil. The common mode choking coil represents a coil that is, for example, composed of a hollow type ferrite core and two wires of a Voltage (in this example, 5V) line and a ground line wound on the hollow type ferrite core several times in reverse direction. In more detail, the common mode choking coil is built into the connector body of the charging device 303 or the cable thereof and can reduce a common mode noise introduced into the two wires of the 5V line and the ground line that construct the common mode choking coil. Thus, the common mode choking coil plays a role of reducing a maximum radiation noise emitted from the electronic device 301. Accordingly, the maximum radiation noise emitted from the electronic device undergoing the RE test is reduced by the common mode choking coil built in the charging device 303 and thus, the reduced noise can be measured by the measurement antenna, meeting a set specification of the RE test. The common mode choking coil can be positioned in the charging device 303 or between a power supply unit of the electronic device 301 and a connector port thereof or between a main board of the electronic device 301 and the power supply unit of the electronic device 301. Accordingly, the common mode choking coil can effectively reduce a radiation noise emitted from the main board of the electronic device 301, the camera thereof, and the ear jack thereof

The common mode choking coil can be provided in any of the electronic device 301 and the charging device 303, as well as in the earphone 302. In more detail, the common mode choking coil can be built in a speaker of the earphone 302 or a microphone thereof and suppress a maximum radiation noise emitted from the electronic device 301. In other words, if the user operates the camera and executes at least one specific application in the electronic device 301, the electronic device 301 emits the maximum radiation noise. If the maximum radiation noise is emitted from the electronic device 301, the common mode choking coil can be positioned between the power supply unit of the electronic device 301 and the connector port thereof or between the main board of the electronic device 301 and the power supply unit thereof and suppress the maximum radiation noise emitted from the electronic device 301. Alternatively, or in addition thereto, the common mode choking coil can be positioned in the connector body of the charging device 303 or the cable thereof and suppress the maximum radiation noise emitted from the electronic device 301. The common mode choking coil may also be positioned in the speaker of the earphone 302 or the microphone thereof and suppress the maximum radiation noise emitted from the electronic device 301.

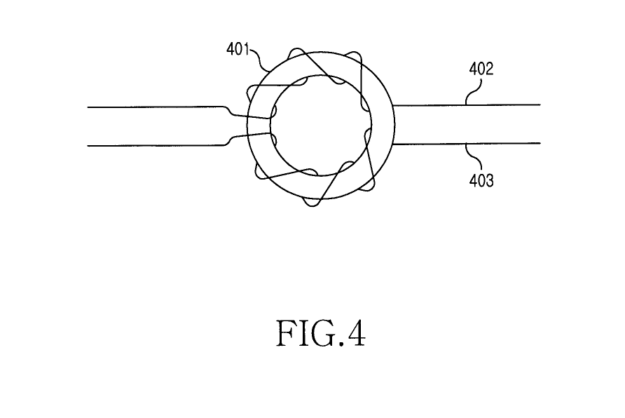

FIG. 4 is a diagram illustrating an exemplary construction of a common mode choking coil according to an exemplary embodiment of the present invention. As illustrated in FIG. 4, the common mode choking coil can include, for example, a hollow type ferrite core 401, a 5V line 402, and a ground line 403. In more detail, the common mode choking coil can be defined as a coil that is composed of the hollow type ferrite core 401 and two wires of the 5V line 402 and the ground line 403 wound on the hollow type ferrite core 401 several times in reverse direction, the common mode choking coil is a coil preferably composed of the hollow type ferrite core 401 and the two wires of the 5V line 402 and the ground line 403 wound on the hollow type ferrite core 401 in reverse direction of the same number of winding. An artisan understands and appreciates that within the spirit and scope of the claimed invention, the line 402 can be other voltages and is not limited to 5 volts, and the ferrite core 401 is preferable but can be constructed of other materials in addition to or in lieu of, but a ferrite core is preferable.

A charging device according to the present invention can include a connector, a connector body, a cable, and an adapter. The common mode choking coil, which is an electronic element that may be included in the connector body of the charging device or the cable thereof, refers to a coil that is composed of the hollow type ferrite core 401 and the two wires of the 5V line 402 and the ground line 403 wound on the hollow type ferrite core 401 several times in reverse direction. Although not illustrated in FIG. 4, the 5V line 402 and the ground line 403 that construct the common mode choking coil can be included in the connector, the connector body, and the cable. In more detail, because the 5V line 402 and the ground line 403 can be included in the connector, and/or the connector body, and/or the cable, the maximum radiation noise emitted from the electronic device can be introduced into the two wires of the 5V line 402 and the ground line 403. Accordingly, the maximum radiation noise introduced into the 5V line 402 and the ground line 403 can be reduced by the common mode choking coil that acts as inductor. Also, a Direct Current (DC) introduced into the 5V line 402 of the cable passes the common mode choking coil and circulates in the electronic device, and again passes the common mode choking coil and returns to the ground line 403. Accordingly, because the direct current does not induce reactance in the common mode choking coil, the charging device can supply power to the electronic device.

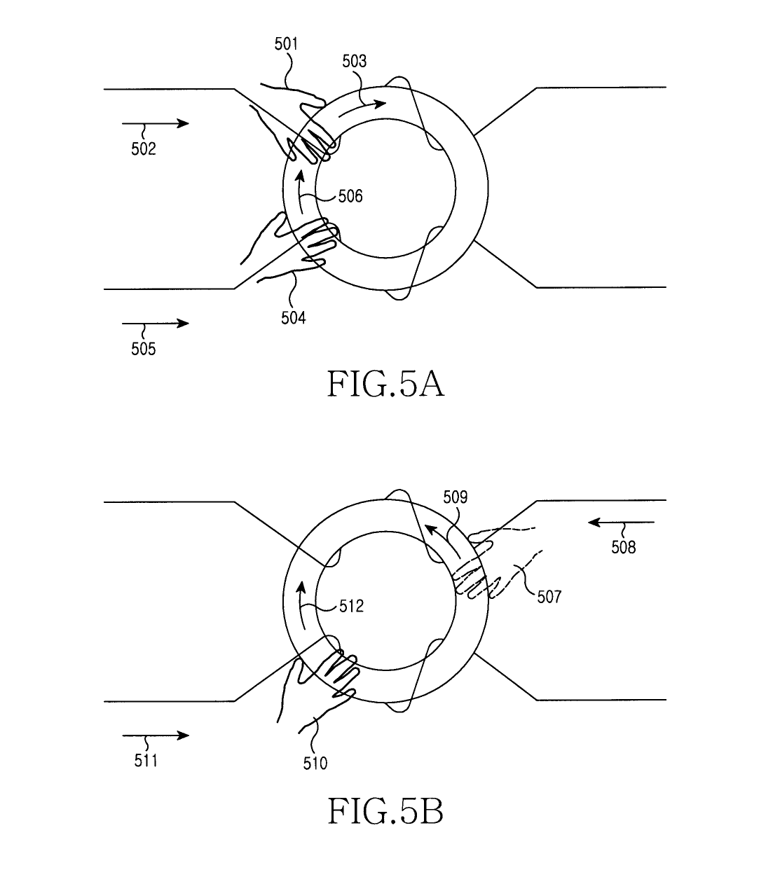

FIGS. 5A and 5B are diagrams illustrating the direction of each magnetic flux when a radiation noise and an electric current pass common mode choking coils according to an exemplary embodiment of the present invention.

FIG. 5A is a diagram illustrating the direction of a magnetic flux dependent on a radiation noise passing a common mode choking coil.

As illustrated in FIG. 5A, a wire constructing the common mode choking coil is wound starting from the upper side of a core of the common mode choking coil toward the lower side thereof, so the core of the common mode choking coil is curled downward with his/her right hand 501. According to Ampere's law, the direction indicated by four fingers of the right hand 501 becomes the direction of an electric current, and the direction indicated by the thumb of the right hand 501 becomes the direction 503 of a magnetic flux. Here, the electric current may include a maximum radiation noise 502 emitted from an electronic device. Accordingly, assuming that the maximum radiation noise 502 is introduced into a 5V line constructing the common mode choking coil, in this example the direction 503 of the magnetic flux dependent on the maximum radiation noise 502 comprises a clockwise direction. In the same manner, a wire constructing the common mode choking coil is wound starting from the lower side of the core of the common mode choking coil toward the upper side thereof, so the user curls the core of the common mode choking coil upward with his/her right hand 504. According to Ampere's law, the direction indicated by four fingers of the right hand 504 becomes the direction of an electric current, and the direction indicated by the thumb of the right hand 504 becomes the direction 506 of a magnetic flux. Here, the electric current may include a maximum radiation noise 505 emitted from an electronic device. Accordingly, assuming that the maximum radiation noise 505 is introduced into a ground line used in constructing the common mode choking coil, the direction 506 of the magnetic flux dependent on the maximum radiation noise 505 follows a clockwise direction as well. In more detail, a common mode noise introduced into the common mode choking coil that is composed of two wires of the 5V line and the ground line induces the magnetic fluxes of the same direction as above and the respective induced fluxes are summed up, so the common mode choking coil acts as inductance. Accordingly, a maximum radiation noise introduced in a common mode into the common mode choking coil is reduced by the common mode choking coil acting as the inductance. In addition, a charging device according to the present invention can be constructed with the common mode choking coil in the connector body or the cable, effectively reducing the maximum radiation noise emitted from the electronic device.

FIG. 5B is a diagram illustrating the direction of a magnetic flux dependent on an electric current passing a common mode choking coil.

As illustrated in FIG. 5B, a wire constructing the common mode choking coil is wound starting from the upper side of a core of the common mode choking coil toward the lower side thereof, so the core of the common mode choking coil is curled downward with his/her right hand 507. According to Ampere's law, the direction indicated by four fingers of the right hand 507 becomes the direction 508 of an electric current, and the direction indicated by the thumb of the right hand 507 becomes the direction 509 of a magnetic flux. Accordingly, assuming that the electric current is introduced into a 5V line constructing the common mode choking coil, the direction 509 of the magnetic flux dependent on the electric current becomes a counterclockwise direction. In the same manner, a wire constructing the common mode choking coil is wound starting from the lower side of the core of the common mode choking coil toward the upper side thereof, so the user curls the core of the common mode choking coil upward with his/her right hand 510. According to Ampere's law, the direction indicated by four fingers of the right hand 510 becomes the direction 511 of an electric current, and the direction indicated by the thumb of the right hand 510 becomes the direction 512 of a magnetic flux. Accordingly, assuming that the electric current is introduced into a ground line constructing the common mode choking coil, the direction 511 of the magnetic flux dependent on the electric current comprises a clockwise direction. In more detail, the respective electric current introduced into the common mode choking coil that is composed of two wires of the 5V line and the ground line as shown in FIG. 5B induce the magnetic fluxes in two different directions (clockwise and counterclockwise) as described herein above and the respective induced fluxes are offset mutually, so the common mode choking coil does not act as inductor. Accordingly, the electric current introduced in a normal mode into the common mode choking coil passes the common mode choking coil not acting as the inductance and supplies power to the electronic device.

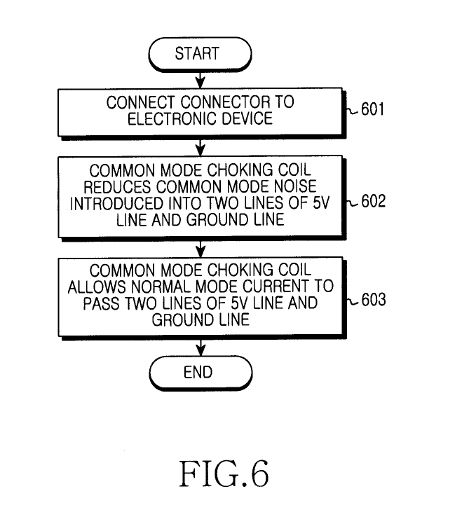

FIG. 6 is a flowchart illustrating an operation of a charging device according to the present invention.

As illustrated in FIG. 6, first, in step 601, a connector of the charging device is connected to an electronic device. In more detail, the connector of the charging device is connected to a connector port of the electronic device, in a state in which a maximum radiation noise can be emitted from the electronic device. Here, the state in which the maximum radiation noise can be emitted refers to not a state in which a user can identify that the maximum radiation noise is emitted from the electronic device prior to connecting the charging device, but that the state in which the maximum radiation noise can be emitted. In other words, it refers to a state in which the maximum radiation noise is not emitted from the electronic device before the charging device is connected to the electronic device, but the maximum radiation noise is emitted from the electronic device only after the charging device is connected to the electronic device. Accordingly, if a user connects an earphone and connects the charging device to the electronic device while undergoing an RE test with operating a camera and executing a specific application in the electronic device, a measurement antenna can measure the maximum radiation noise emitted from the electronic device.

At step 602, a common mode choking coil of the charging device reduces a common mode noise introduced into two wires of a 5V line and a ground line constructing the common mode choking coil. In more detail, because the 5V line and the ground line can be included in a connector of the charging device, a connector body thereof, and a cable thereof, the maximum radiation noise emitted from the electronic device can be introduced into the common mode choking coil composed of the two wires of the 5V line and the ground line. Accordingly, the common mode noise introduced into the 5V line and the ground line can be reduced by the common mode choking coil acting as an inductor.

At step 603, the common mode choking coil of the charging device passes a normal mode current through the two wires of the 5V line and the ground line at the same time of reducing the common mode noise introduced into the two wires of the 5V line and the ground line. In more detail, because the 5V line and the ground line can be included in the connector of the charging device, the connector body thereof, and the cable thereof, a direct current introduced into the 5V line of the cable passes the common mode choking coil and circulates in the electronic device, and again passes the common mode choking coil and returns to the ground line. Accordingly, because the direct current does not cause inductance when passing through the common mode choking coil, the charging device can supply power to the electronic device yet noise of higher frequencies is choked off.

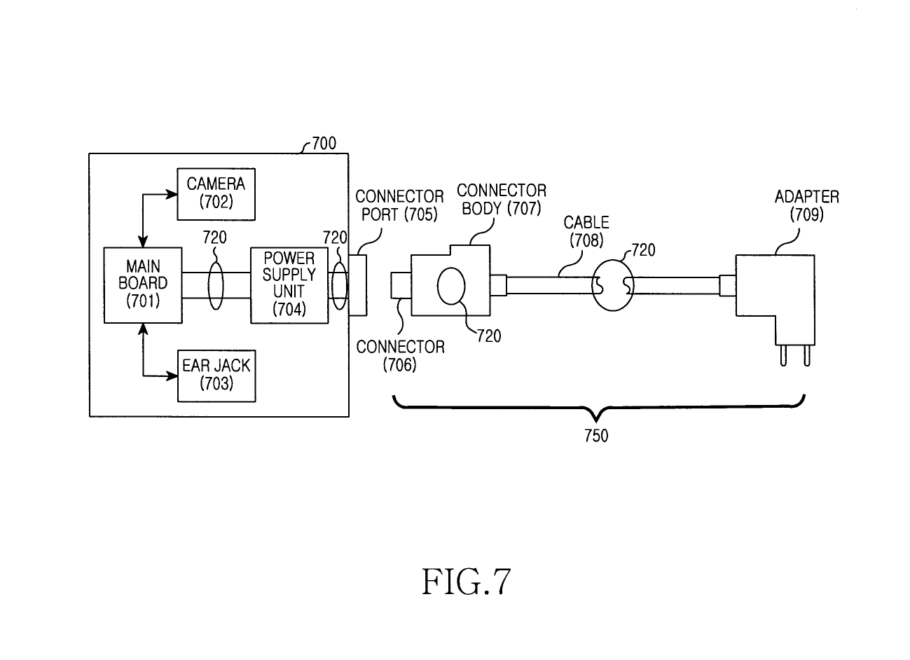

FIG. 7 is a block diagram illustrating exemplary constructions of an electronic device and a charging device according to an exemplary embodiment of the present invention.

As illustrated in FIG. 7, the electronic device 700 according to this example of the present invention can include a main board 701, a camera 702, an ear jack 703, a power supply unit 704, and a connector port 705.

The main board 701 is connected with the camera 702, the ear jack 703, and the power supply unit 704. In more detail, if various applications are being executed, the main board 701 emits various levels of radiation noise that correlate to the corresponding application(s) being operated that utilize associated hardware. For example, as the main board 701 is connected with the camera 702, the main board 701 emits various radiation noise that is radiated from the camera 702, particularly when the camera 702 is being driven. Also, the main board 701 also emits various radiation noise radiated from the ear jack 703 when connected with the ear jack 703, when an earphone is connected to device the ear jack 703.

The main board 701 receives an input instruction for driving the camera 702 from a user, and drives the camera 702. Also, because the camera 702 is connected with the main board 701, as the camera 702 is driven, the camera 702 directly emits a radiation noise, or forwards the radiation noise to the main board 701 and allows the main board 701 to emit the radiation noise.

The ear jack 703 is a component adapted for connection with the earphone. In more detail, the ear jack 703 forwards an electrical signal generated in the electronic device, to the earphone, and receives an input of an electrical signal from the earphone. Also, a maximum radiation noise emitted from the electronic device at RE testing is forwarded to the earphone through the ear jack 703 of the electronic device. If an earphone (not shown) is connected with the ear jack 703, the ear jack 703 may directly emit a radiation noise, or may forward the radiation noise to the main board 701 and allow the main board 701 to emit the radiation noise. An artisan will understand and appreciate that the term “earphone” encompasses a number of various devices within the scope of the claimed invention that connect to the electronic device via the ear jack 703, wired or wirelessly.

The power supply unit 704 supplies power to the electronic device, and is connected with the main board 701 and the connector port 705. In more detail, a common mode choking coil according to the present invention can be provided between the main board 701 and the power supply unit 704, or can be provided between the power supply unit 704 and the connector port 705.

The connector port 705 is a component used to electrically couple (connect) with a connector 706 of the charging device. The common mode choking coil 720 may be provided between the power supply unit 704 and the connector port 705.

The charging device 750 according to the present invention can include the connector 706, a connector body 707, a cable 708, and an adapter 709. The connector 706 can be electrically coupled with the connector port 705 of the electronic device, and is connected with the connector body 707 of the charging device. In more detail, the connector 706 may include two wires of a voltage (for example 5V but not limited thereto in any way) line and a ground line that construct the common mode choking coil. In other words, because the two wires of the 5V line and the ground line constructing the common mode choking coil can be included in the connector 706, the connector 706 will introduce a radiation noise emitted from the electronic device into the 5V line and the ground line, and can forward the radiation noise to the connector body 707. Also, the connector 706 can provide a direct current introduced from the connector body 707, to the electronic device through the 5V line, and can receive a direct current that is again introduced from the electronic device to the ground line.

With continued reference to FIG. 7, an artisan should appreciate that while the common mode choking coil (CMCC) 720 is shown in various arrangements of the electronic device 700 and charging unit 750, only one such arrangement of the CMCC can reduce the electromagnetic radiation, although it is possible to arrange the CMCCs 720 at more than one position, some examples of which being shown in FIG. 7. The connector body 707 is provided between the connector 706 and the cable 708. The connector body 707 can include a common mode choking coil 720. In more detail, the connector body 707 can include the common mode choking coil 720 and reduce a radiation noise introduced in a common mode from the electronic device.

The cable 708 is provided between the connector body 707 and the adapter 709. The cable 708 can include a common mode choking coil. In more detail, the cable 708 can include the common mode choking coil and reduce a radiation noise introduced in the common mode from the electronic device.

The adapter 709 converts an Alternating Current (AC) provided from a wall outlet, into a direct current, and introduces the direct current to the cable 708. That is, the adapter 709 plays a role of supplying power to the electronic device.

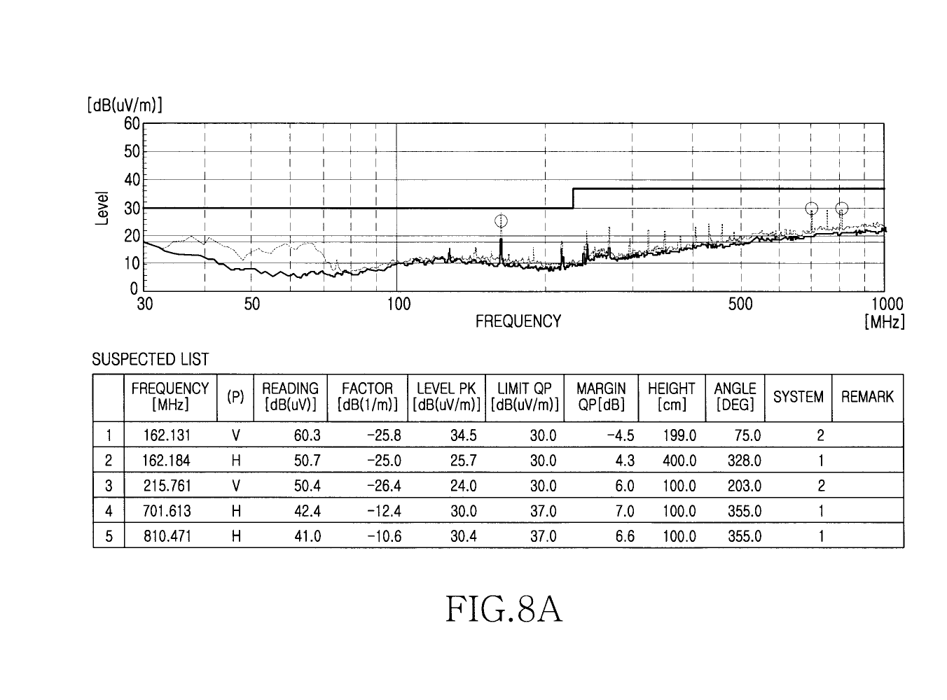

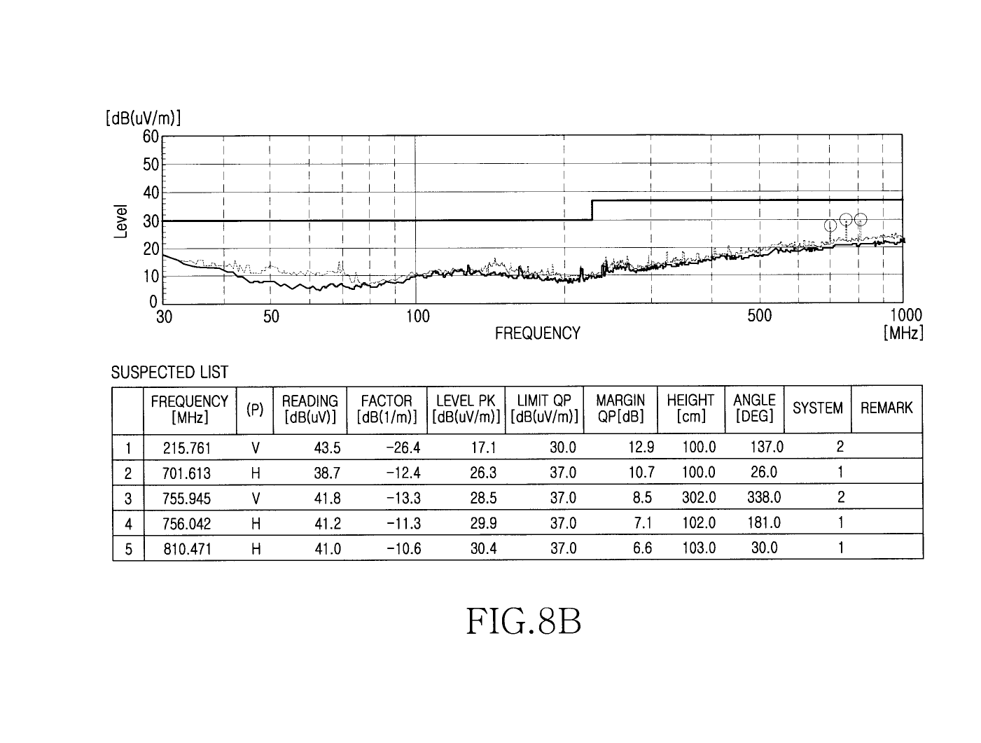

FIGS. 8A and 8B are graphs illustrating exemplary embodiments of experimentally measuring a radiation noise emitted from an electronic device before and after using a common mode choking coil according to the present invention. First, terms used in this experiment are defined as follows:
‘Reading’: an actual measurement value,
‘Factor’: a correction value of a measurement equipment,
‘Level PK’: a measurement peek value,
‘Limit QP’: a corresponding specification quasi peek, and
‘Margin QP’: a margin quasi peek.

FIG. 8A is a graph illustrating an exemplary embodiment of experimentally measuring a radiation noise emitted from an electronic device prior to including a common mode choking coil according to the present invention. FIG. 8B is a graph illustrating an exemplary embodiment of experimentally measuring a radiation noise emitted from the electronic device after including the common mode choking coil according to the present invention. In more detail, the X-axis of this graph represents frequency, and Y-axis represents a Level PK value. First, if comparing the graphs of FIGS. 8A and 8B from macroscopic viewpoint, it can be appreciated that a Level PK value of FIG. 8A approaches a bolded line (i.e., a specification). In contrast, it can be identified that, compared with FIG. 8A, a measured Level PK value of FIG. 8B is far distant from the bolded line at high frequency as well as low frequency.

Firstly, when comparing ‘Reading’ values that are actual measurement values, it can be identified that, at the same frequency 215.761 Mega Hertz (MHz), the ‘Reading’ value of FIG. 8A was measured to be 50.4 decibel (dB), and the ‘Reading’ value of FIG. 8B was measured to be 43.5 dB, which is remarkably low. Also, it can be identified from FIG. 8A that, although the frequency is increased to 701.613 MHz, the ‘Reading’ value of FIG. 8A was measured to be 42.4 dB, and the ‘Reading’ value of FIG. 8B was measured to be 38.7 dB, which is remarkably low.

Secondly, if comparing Level PK values that are measurement peak values, it can be identified that, at the same frequency of 701.613 MHz, the Level PK value of FIG. 8A was measured to be 30.0 dB, and the Level PK value of FIG. 8B was measured to be 26.3 dB remarkably low.

Lastly, if comparing margin QP values that are margin quasi peek values, it can be identified that, at the same frequency 215.761 MHz, the margin QP value of FIG. 8A was measured to be 6.0 dB, and the margin QP value of FIG. 8B was measured to be 12.9 dB, which is remarkably high. Also, it can be identified that, although the frequency is increased to 701.613 MHz, the margin QP value of FIG. 8A was measured to be 7.0 dB, and the margin QP value of FIG. 8B was measured to be 10.7 dB, which is also remarkably high. In other words, that the high margin QP value is measured means that there is a big difference with the bolded line (i.e., the specification), and it can be identified that a measured radiation noise is less as much.

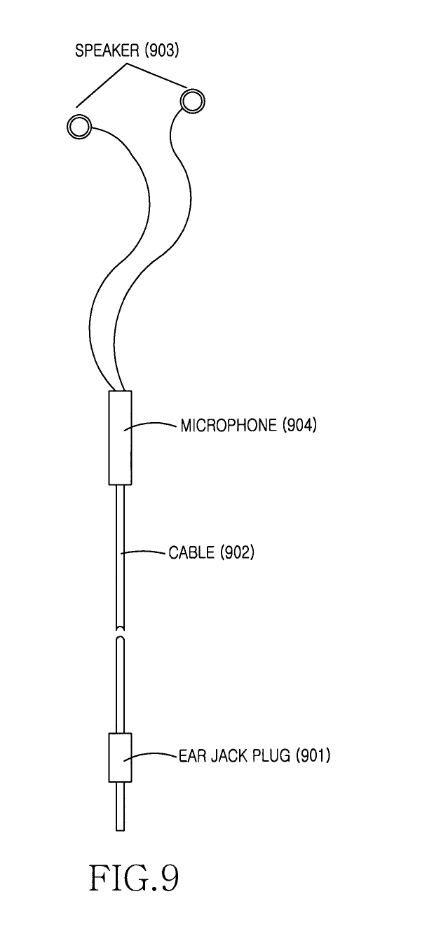

FIG. 9 is a diagram illustrating a construction of an earphone according to an exemplary embodiment of the present invention.

As illustrated in FIG. 9, the earphone according to the present invention can include an ear jack plug 901, a cable 902, a speaker 903, and a microphone 904.

The ear jack plug 901 is a part electrically connecting with an ear jack of an electronic device. Through the ear jack plug 901 of the earphone, an electrical signal generated in the electronic device is forwarded to the earphone. Also, through the ear jack plug 901 of the earphone, an electrical signal generated in the earphone is forwarded to the electronic device. Also, through the ear jack plug 901 of the earphone, a maximum radiation noise emitted from the electronic device at RE testing is forwarded to the earphone.

The cable 902 refers to a component provided between the ear jack plug 901 and the speaker 903. In other words, the ear jack plug 901 is connected to one end of the cable 902, and the speaker 903 is connected to the other end of the cable 902. In more detail, the cable 902 forwards an electrical signal forwarded through the ear jack plug 901, to the speaker 903.

The speaker 903 is provided at the other end of the cable 902. The speaker 903 receives an input of an electrical signal from the electronic device, reproduces a voice signal, and generates a sound source. Also, the speaker 903 can include a common mode choking coil and cut off a maximum radiation noise that is emitted from the electronic device at RE testing.

The microphone 904 is positioned between the ear jack plug 901 and the speaker 903, and receives an input of a voice signal from a user. Also, the microphone 904 can include a common mode choking coil and cut off a maximum radiation noise that is emitted from the electronic device at RE testing.

According to a noise reduction apparatus of the present invention, there is an effect of effectively reducing a radiation noise emitted from an electronic device, by building common mode choking coils in the electronic device and a charger or earphone.

Methods according to exemplary embodiments described in claims and/or specification of the present invention may be implemented in the form of machine executable code loaded into hardware, hardware, or a combination of these such that the appended claims in a broadest reasonable interpretation are in full compliance with 35 U.S.C. §101 and none of the appended claims or elements therein constitute software per se.

The above-described methods according to the present invention can be implemented in hardware, firmware or as software or computer code that is stored in a recording medium such as a CD ROM, flash, EPROM, EEPROM, RAM, a floppy disk, thumbnail drive, a hard disk, or a magneto-optical disk or computer code downloaded over a network originally stored on a remote recording medium and then stored on a non-transitory medium and loaded into hardware such as a processor or microprocessor. The machine executable code stored on the non-transitory machine readable medium can be stored on a local recording medium, and loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” or “unit” constitute hardware in the claimed invention. Finally, the claimed invention can include the use of a location information server comprising more than one server, such as a proxy server.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for reducing an Electro-Magnetic Interference (EMI) noise of an electronic device while receiving power from a charging device, the apparatus comprising:
at least one Common Mode Choking Coils (CMCC) arranged in the charging device within a path of the power supply line that supplies power to charge the electronic device, or within in an earphone connected with the electronic device wherein the at least one CMCC being arranged to reduce a radiation noise emitted out from the electronic device at the time of interworking with the charging device.

2. The apparatus of claim 1, wherein the charging device comprises:
an adapter for converting Alternating Current (AC) power supplied from an external source into Direct Current (DC) power;
a cable of a predetermined length having one end electrically coupled to the adapter; and
a connector body comprising a connector that is arranged at the other end of the cable and is electrically coupled to a connector port of the electronic device,
wherein the at least one CMCC is interposed in any one of the connector body, the cable, and the adapter that are in the power supply line of the charging device.

3. The apparatus of claim 2, wherein said at least one CMCC comprises a plurality of CMCCs at least one of which being arranged in the earphone, and another of the plurality of CMCCs arranged in at least one of the connector body, the cable, and the adapter that are in the power supply line of the charging device.

4. The apparatus of claim 1, wherein the electronic device comprises:
a connector port electrically coupled with a connector of the charging device;
a power supply unit electrically coupled with the connector port, and receiving power applied from the charging device; and
a main board comprising a processor operating by power applied from the power supply unit,
wherein the at least one CMCC is arranged between the connector port and the power supply unit, or between the power supply unit and the main board.

5. The apparatus of claim 1, wherein the earphone comprises:
an ear jack plug electrically coupled with an ear jack of the electronic device;
a cable of a predetermined length having one end electrically coupled to the ear jack plug;
a speaker arranged at the other end of the cable, and receiving an input of an electrical signal from the electronic device, reproducing a voice signal, and generating a sound source; and
a microphone positioned between the ear jack plug and the speaker, and receiving an input of a voice signal from a user,
wherein the at least one CMCC is arranged with a path of the speaker or the microphone.

6. The apparatus of claim 1, wherein the at least one CMCC comprises a hollow type ferrite core, at least one voltage line and a ground line that are wound on the hollow type ferrite core in a reverse direction.

7. The apparatus of claim 6, wherein the at least one CMCC reduces a common mode noise introduced into the at least one voltage line and the ground line of the at least one CMCC.

8. The apparatus of claim 6, wherein the at least one CMCC passes a normal mode current to pass through the at least one voltage line and the ground line of the at least one CMCC without attenuation.

9. The apparatus of claim 1, wherein the at least one CMCC provides inductance for the radiation noise emitted from the electronic device.

10. The apparatus of claim 1, wherein during operation of the electronic device while being charged by the charging device a maximum radiation noise produced by the electronic device is reduced while the electronic device performs at least one function at the same time during a charging operation by the charging device.

11. The apparatus of claim 9, wherein the electronic device performs at least one of a camera function and at least one application execution function during the charging operation.

12. The apparatus of claim 1, wherein the electronic device comprises a portable communication terminal.

13. A charging device for charging an electronic device, the charging device comprising:
an adapter for converting Alternating Current (AC) power supplied from an external source, into Direct Current (DC) power;
a cable of a predetermined length having one end electrically coupled to the adapter;
a connector body comprising a connector arranged at another end of the cable and electrically coupled to a connector port of the electronic device; and
a Common Mode Choking Coil (CMCC) arranged in any one of the connector body, the cable, and the adapter that are within a path of a power supply line that supplies power from the charging device,
wherein the CMCC of the charging device reduces a radiation noise emitted from the electronic device during charging of the electronic device.

14. The charging device of claim 13, wherein the CMCC comprises a hollow type ferrite core and at least one voltage line and a ground line that are wound on the hollow type ferrite core in a reverse direction.

15. The charging device of claim 14, wherein the CMCC reduces a common mode noise introduced into the at least one voltage line and the ground line of the CMCC.

16. The charging device of claim 14, wherein the CMCC permits a normal mode current to pass through the voltage line and the ground line of the CMCC without attenuation.

17. An electronic device for receiving power supply from a charging device, the electronic device comprising:
a connector port electrically coupled with a connector of the charging device;
a power supply unit electrically coupled with the connector port, and accepting power applied from the charging device;
a main board comprising a processor unit operating by power supplied from the power supply unit; and
a Common Mode Choking Coil (CMCC) arranged in a signal path in any one of the connector port and the power supply unit and between the power supply unit and the main board,
wherein the electronic device reduces a radiation noise emitted from the electronic device during a charging operation by the charging device.

18. The electronic device of claim 17, wherein the CMCC comprises a hollow type ferrite core and at least one voltage (V) line and a ground line that are wound on the hollow type ferrite core in a reverse direction.

19. The electronic device of claim 18, wherein the common mode choking coil reduces a common mode noise introduced into the wires of the voltage line and the ground line of the CMCC.

20. The electronic device of claim 18, wherein the common mode choking coil allows a normal mode current to pass the voltage line and the ground line of the common mode choking coil.

21. An earphone for reducing a noise emitted from an electronic device, the earphone comprising:
an ear jack plug electrically coupled with an ear jack of the electronic device;
a cable of a predetermined length whose one end is electrically coupled to the ear jack plug;
a speaker arranged at the another end of the cable, and receiving an input of an electrical signal from the electronic device, reproducing a voice signal, and generating a sound source;
a microphone positioned between the ear jack plug and the speaker, and receiving an input of a voice signal from a user; and
a Common Mode Choking Coil (CMCC) arranged within a signal path of any one of the speaker and the microphone,
wherein the CMCC of the earphone reduces a radiation noise emitted from the electronic device during charging of the electronic device.

22. The earphone claim 21, wherein the CMCC comprises a hollow type ferrite core and at least one voltage (V) line and a ground line that are wound on the hollow type ferrite core in a reverse direction.

23. The earphone claim 22, wherein the CMCC reduces a common mode noise introduced into the voltage line and the ground line of the CMCC.

24. The earphone claim 22, wherein the CMCC allows a normal mode current to pass the voltage line and the ground line of the CMCC without attenuation.
